(19) United States
(12) Patent Application Publication
(10) Pub. No.: US 2016/0116780 A1
(43) Pub. Date: Apr. 28, 2016

(54) DISPLAY PANEL AND DISPLAY APPARATUS

(71) Applicant: Shenzhen China Star Optoelectronics Technology Co. Ltd., Shenzhen (JP)

(72) Inventors: Jinbo GUO, Shenzhen (CN); Shih-Hsun LO, Shenzhen (CN); Shishuai HUANG, Shenzhen (CN)

(21) Appl. No.: 14/234,405

(22) PCT Filed: Jan. 6, 2014
(86) PCT No.: PCT/CN2014/070154

§ 371 Date: Jan. 23, 2014

(30) Foreign Application Priority Data
Dec. 27, 2013 (CN) 20130739108.8

(51) Int. Cl. G02F 1/1339; G02F 1/1343; G02F 1/1335

(52) U.S. Cl. CPC G02F 1/13394; G02F 1/133514; G02F 1/134309

(57) ABSTRACT

The present invention provides a display panel and a display apparatus. A TFT array substrate of the display panel comprises first pixels, second pixels and third pixels. The second pixels and third pixels are adjacent to the first pixels. The first pixels, second pixels and third pixels include main stages, first dummy stages and second dummy stage, respectively. A CF substrate comprises main spacers, first dummy spacers and second spacers, and the main stages are in contact with the main spacers. The present invention can maintain a PS ratio.

### FIELD OF THE INVENTION

The present invention relates to a display technical field, and more particularly to a display panel and a display apparatus.

### BACKGROUND OF THE INVENTION

In general, a conventional liquid crystal display (LCD) comprises a backlight module and a display panel, and the backlight module and display panel are assembled as one piece.

As shown in FIG. 1, a display panel comprises a thin film transistor (TFT) array substrate 10 and a color filter (CF) substrate 20. Photo spacers (PS) 201 are disposed on the CF substrate 20. Stages 1011 are disposed on the TFT array substrate 10 and corresponding to the photo spacers 201. The photo spacers 201 and the stages 1011 are configured to space the TFT array substrate 10 from the CF substrate 20, so as to receive liquid crystal molecules in a gap there-between for forming a liquid crystal layer 30.

In general, a PS ratio of an area of conventional photo spacers 201 to an area of a panel display region is less than 2%.

In practice, there are the following problems existing in the conventional technology.

The PS ratio will affect a display quality of the display panel. If the PS ratio is too large, the display panel is not easy to restore when experiencing the external force, and the light leakage easily occurs.

If the ratio is too large, when the display panel is not easy to restore the external force, and is easy to light leakage. If the ratio is too small, it is hard to ensure the uniformity of the gap.

In the above-mentioned LCD manufacturing process, the thin film transistor array substrate 10 and the color filter substrate 20 are difficult to completely overlap with each other. The stages 1011 with a larger area are required to support the photo spacers 201 for ensuring the gap between the thin film transistor array substrate 10 and the color filter substrate 20. However, the larger area of the stages 1011 will reduce an aperture ratio of pixels, thereby deteriorating the display quality.

As a result, it is necessary to provide a new technology to solve the problems existing in the conventional technologies, as described above.

### SUMMARY OF THE INVENTION

The present invention provides a display panel and a display apparatus, so as to ensure an aperture ratio of pixels without varying the PS ratio of an area of spacers to an area of a panel display region.

A primary object of the present invention is to provide a display panel, wherein the display panel comprises: a thin film transistor (TFT) array substrate; a color filter (CF) substrate assembled to the TFT array substrate; and a liquid crystal layer disposed between the TFT array substrate and the CF substrate; wherein the TFT array substrate includes at least two pixel units, and the pixel units comprise first pixels, second pixels and third pixels, and the second pixels are adjacent to the first pixels in a first direction, and the third pixels are adjacent to the first pixels in a second direction, and the first pixels include main stages, and the second pixels include first dummy stages, and the third pixels include second dummy stages; wherein the CF substrate includes at least one spacer assembly, and the spacer assembly comprises main spacers, first dummy spacers and second spacers; wherein the main stages on the TFT array substrate are positioned to the main spacers on the CF substrate, and the main stages are in contact with the main spacers; wherein, when a position deviation occurs between the main stages and the main spacers, the first dummy spacers are positioned to and supported by the first dummy stages; wherein, when another position deviation occurs between the main stages and the main spacers, the second dummy spacers are positioned to and supported by the second dummy stages.

In the above-mentioned display panel, on a plane of the display panel, a projection of the first dummy spacer is positioned in front of a projection of the first dummy stage in the first direction, and a projection of the second spacer is positioned in front of a projection of the second dummy stage in the second direction.

In the above-mentioned display panel, a length of the main stages in a direction perpendicular to the first direction is greater than a length of the main spacers in the direction.

In the above-mentioned display panel, the pixel units further comprise fourth pixels and fifth pixels, and the fourth pixels are adjacent to the first pixels in a third direction, and the fifth pixels are adjacent to the first pixels in a fourth direction, and the fourth pixels include third dummy stages, and the fifth pixels include fourth dummy stages, and the spacer assembly further comprises third dummy spacers and fourth spacers.

In the above-mentioned display panel, on a plane of the display panel, a projection of the third dummy spacer is positioned in front of a projection of the third dummy stage in the third direction, and a projection of the fourth spacer is positioned in front of a projection of the fourth dummy stage in the fourth direction.

In the above-mentioned display panel, the fourth dummy spacers are positioned to and supported by the fourth dummy stages when a position deviation in the third direction occurs between the TFT array substrate and the CF substrate, and the fifth dummy spacers are positioned to and supported by the fifth dummy stages when a position deviation in the fourth direction occurs between the TFT array substrate and the CF substrate.

Another object of the present invention is to provide a display panel, wherein the display panel comprises: a TFT array substrate; a CF substrate assembled to the TFT array substrate; and a liquid crystal layer disposed between the TFT array substrate and the CF substrate; wherein the TFT array substrate includes at least two pixel units, and the pixel units comprise first pixels, second pixels and third pixels, and the second pixels are adjacent to the first pixels in a first direction, and the third pixels are adjacent to the first pixels in a second direction, and the first pixels include main stages, and the second pixels include first dummy stages, and the third pixels include second dummy stages; wherein the CF substrate includes at least one spacer assembly, and the spacer assembly comprises main spacers, first dummy spacers and second spacers; wherein the main stages on the TFT array substrate are positioned to the main spacers on the CF substrate, and the main stages are in contact with the main spacers.

In the above-mentioned display panel, the first dummy spacers are positioned to and supported by the first dummy stages when a position deviation occurs between the main stages and the main spacers, and the second dummy spacers are positioned to and supported by the second dummy stages when another position deviation occurs between the main stages and the main spacers.

In the above-mentioned display panel, on a plane of the display panel, a projection of the first dummy spacer is positioned in front of a projection of the first dummy stage in the first direction, and a projection of the second spacer is positioned in front of a projection of the second dummy stage in the second direction.

In the above-mentioned display panel, a length of the main stages in a direction perpendicular to the first direction is greater than a length of the main spacers in the direction.

In the above-mentioned display panel, the pixel units further comprise fourth pixels and fifth pixels, and the fourth pixels are adjacent to the first pixels in a third direction, and the fifth pixels are adjacent to the first pixels in a fourth direction, and the fourth pixels include third dummy stages, and the fifth pixels include fourth dummy stages, and the spacer assembly further comprises third dummy spacers and fourth spacers.

In the above-mentioned display panel, on a plane of the display panel, a projection of the third dummy spacer is positioned in front of a projection of the third dummy stage in the third direction, and a projection of the fourth spacer is positioned in front of a projection of the fourth dummy stage in the fourth direction.

In the above-mentioned display panel, the fourth dummy spacers are positioned to and supported by the fourth dummy stages when a position deviation in the third direction occurs between the TFT array substrate and the CF substrate, and the fifth dummy spacers are positioned to and supported by the fifth dummy stages when a position deviation in the fourth direction occurs between the TFT array substrate and the CF substrate.

Still another object of the present invention is to provide a display apparatus, comprising a backlight module and a display panel comprising: a TFT array substrate; a CF substrate assembled to the TFT array substrate; and a liquid crystal layer disposed between the TFT array substrate and the CF substrate; wherein the TFT array substrate includes at least two pixel units, and the pixel units comprise first pixels, second pixels and third pixels, and the second pixels are adjacent to the first pixels in a first direction, and the third pixels are adjacent to the first pixels in a second direction, and the first pixels include main stages, and the second pixels include first dummy stages, and the third pixels include second dummy stages; wherein the CF substrate includes at least one spacer assembly, and the spacer assembly comprises main spacers, first dummy spacers and second spacers; wherein the main stages on the TFT array substrate are positioned to the main spacers on the CF substrate, and the main stages are in contact with the main spacers.

In the above-mentioned display apparatus, the first dummy spacers are positioned to and supported by the first dummy stages when a position deviation occurs between the main stages and the main spacers, and the second dummy spacers are positioned to and supported by the second dummy stages when another position deviation occurs between the main stages and the main spacers.

In the above-mentioned display apparatus, on a plane of the display panel, a projection of the first dummy spacer is positioned in front of a projection of the first dummy stage in the first direction, and a projection of the second spacer is positioned in front of a projection of the second dummy stage in the second direction.

In the above-mentioned display apparatus, a length of the main stages in a direction perpendicular to the first direction is greater than a length of the main spacers in the direction.

In the above-mentioned display apparatus, the pixel units further comprise fourth pixels and fifth pixels, and the fourth pixels are adjacent to the first pixels in a third direction, and the fifth pixels are adjacent to the first pixels in a fourth direction, and the fourth pixels include third dummy stages, and the fifth pixels include fourth dummy stages, and the spacer assembly further comprises third dummy spacers and fourth spacers.

In the above-mentioned display apparatus, on a plane of the display panel, a projection of the third dummy spacer is positioned in front of a projection of the third dummy stage in the third direction, and a projection of the fourth spacer is positioned in front of a projection of the fourth dummy stage in the fourth direction.

In the above-mentioned display apparatus, the fourth dummy spacers are positioned to and supported by the fourth dummy stages when a position deviation in the third direction occurs between the TFT array substrate and the CF substrate, and the fifth dummy spacers are positioned to and supported by the fifth dummy stages when a position deviation in the fourth direction occurs between the TFT array substrate and the CF substrate.

In comparison with the conventional technology, the dummy stages are disposed on the TFT array substrate, and the dummy spacers are disposed on the CF substrate, and the first dummy spacers and the second dummy spacers are positioned at different sides of the first dummy stages and the second dummy stage, respectively. Therefore, when a position deviation occurs between the TFT array substrate and the CF substrate, the dummy spacers can be positioned to and supported by the dummy stages, so as to ensure an aperture ratio of pixels without varying the PS ratio of an area of spacers to an area of a panel display region.

The structure and the technical means adopted by the present invention to achieve the above-mentioned and other objects can be best understood by referring to the following detailed description of the preferred embodiments and the accompanying drawings.

### DESCRIPTION OF THE DRAWINGS

FIG. 1 is a cross-sectional view showing a conventional LCD;

FIG. 2 is a schematic diagram showing a display panel according to a first embodiment of the present invention;

FIG. 3 is a schematic diagram showing a display panel according to a second embodiment of the present invention; and

FIG. 4 is a schematic diagram showing a display panel according to a third embodiment of the present invention.

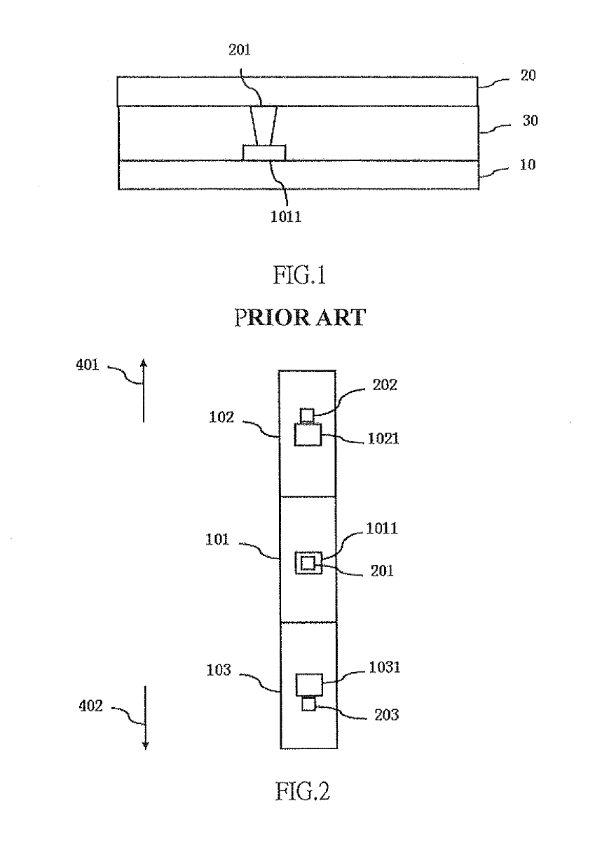

### DETAILED DESCRIPTION OF THE PREFERRED EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

The display apparatus of the present embodiment comprises a backlight module and a display panel, and the backlight module and display panel are assembled as one-piece. The display panel may be a liquid crystal display (LCD) panel. The display apparatus of the present invention may be configured to display 2D images or 3D images, and further may be a 2D/3D switch-able display.

Referring to FIG. 2, a schematic diagram showing a display panel according to a first embodiment of the present invention is illustrated.

The display panel of the present embodiment comprises a thin film transistor (TFT) array substrate 10, a color filter (CF) substrate 20 and a liquid crystal layer 30. The CF substrate 20 is assembled to the TFT array substrate 10, and the liquid crystal layer 30 is disposed between the TFT array substrate 10 and the CF substrate 20.

In this case, the TFT array substrate 10 includes at least two pixel units, and the pixel units comprise first pixels 101, second pixels 102 and third pixels 103, and the second pixels 102 are adjacent to the first pixels 101 in a first direction 401, and the third pixels 103 are adjacent to the first pixels 101 in a second direction 402, and the first pixels include main stages 1011, and the second pixels 102 include first dummy stages 1021, and the third pixels include second dummy stages 1031.

The CF substrate 20 includes at least one spacer assembly, and the spacer assembly comprises main spacers 201, first dummy spacers 202 and second spacers 203.

The main stages 1011 on the TFT array substrate 10 are positioned to the main spacers 201 on the CF substrate 20, and the main stages 1011 are in contact with the main spacers 201.

In the display panel of the present embodiment, the first direction 401 is opposite to the second direction 402. Specifically, the first direction 401 (or the second direction 402) is parallel to a lengthwise direction of the first pixels 101. For example, the first direction 401 can be expressed as a +Y axis direction, and the second direction 402 can be expressed as a −Y axis direction.

In the display panel of the present embodiment, on a plane of the display panel, a projection of the first dummy spacer 202 is positioned in front of a projection of the first dummy stage 1021 in the first direction 401. That is, in the +Y axis direction, a coordinate value of the projection of the first dummy spacer 202 is larger than a coordinate value of the projection of the first dummy stage 1021. In the second direction 402, a projection of the second spacer 203 is positioned in front of a projection of the second dummy stage 1031. That is, in the −Y axis direction, an absolute coordinate value of the projection of the second spacer 203 is larger than an absolute coordinate value of the projection of the second dummy stage 1031.

Preferably, the projection of the first dummy spacer 202 is adjacent to the projection of the first dummy stages 1021, and the projection of the second spacer 203 is adjacent to the projection of the second dummy stage 1031.

On a plane of the display panel, a projected area of the main stages 1011 is larger than a projected area of the main spacers 201, and a projected area of the first dummy stages is larger than a projected area of the first dummy spacers 202, and a projected area of the second dummy stages is larger than a projected area of the second dummy spacers 203.

In the display panel of the present embodiment, when the TFT array substrate 10 is positioned to the CF substrate 20, the main stages 1011 are in contact with the main spacers 201. At this time, only the main stages 1011 and the main spacers 201 are used to space the TFT array substrate 10 and the CF substrate 20. When a position deviation occurs between the TFT array substrate 10 and the CF substrate 20, the main spacers 201 may be not positioned to or supported by the main stages 1011. At this time, the dummy spacers (the first dummy spacers 202 or the second dummy spacers 203) can be positioned to and supported by the dummy stages (the first dummy stages 1021 or the second dummy stage 1031), thereby ensuring the support between the TFT array substrate 10 and the CF substrate 20 as well as maintain a PS ratio of an area of spacers to an area of a panel display region.

In the display panel of the present embodiment, the dummy stages (the first dummy stages 1021 or the second dummy stage 1031) are disposed on the TFT array substrate 10, and the dummy spacers (the first dummy spacers 202 or the second dummy spacers 203) are disposed on the CF substrate 20, and the first dummy spacers 202 and the second dummy spacers 203 are positioned at different sides (in the first direction 401 and the second direction 402) of the first dummy stages 1021 and the second dummy stage 1031, respectively. For example, when the CF substrate 20 is shifted a distance with respect to the TFT array substrate 10 in the first direction 401, the second dummy spacers 203 can also be shifted to and thus in contact with the second dummy stage 1031. Furthermore, for example, when the CF substrate 20 is shifted a distance with respect to the TFT array substrate 10 in the second direction 402, the first dummy spacers 202 can also be shifted to and thus in contact with the first dummy stages 1021. Therefore, the support between the TFT array substrate 10 and the CF substrate 20 can be ensured without varying the PS ratio of an area of spacers to an area of a panel display region, and an aperture ratio of pixels can be enhanced.

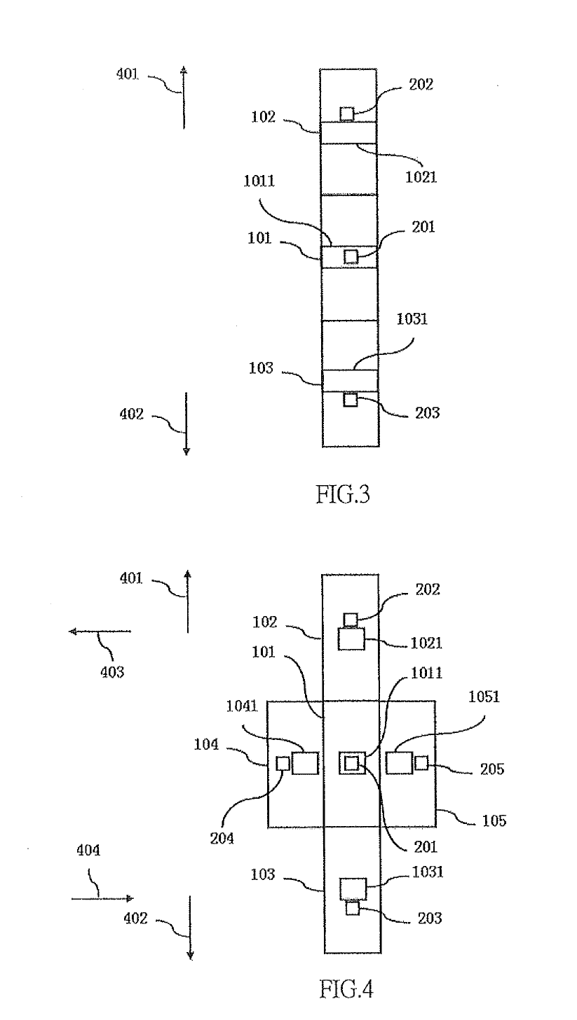

Referring to FIG. 3, a schematic diagram showing a display panel according to a second embodiment of the present invention is illustrated. The second embodiment is similar to the first embodiment, and the differences there-between are explained in further detail below.

In the display panel of the present embodiment, a length of the main stages 1011 in a direction perpendicular to the first direction 401 is greater than a length of the main spacers 201 in the direction. Preferably, in the direction perpendicular to the first direction 401, the main spacer 201 is positioned at the middle of the main stage 1011.

A length of the first dummy stages 1021 in the direction perpendicular to the first direction 401 is greater than a length of the first dummy spacers 202 in the direction. Preferably, in the direction perpendicular to the first direction 401, the first dummy spacer 202 is positioned at the middle of the first dummy stage 1021.

A length of the second dummy stages 1031 in the direction perpendicular to the first direction 401 is greater than a length of the second dummy spacers 203 in the direction. Preferably, in the direction perpendicular to the first direction 401, the second dummy spacer 203 is positioned at the middle of the second dummy stage 1031.

In the display panel of the present embodiment, the main stage 1011, the first dummy stage 1021 and the second dummy stages 1031 have longer lengths in the direction perpendicular to the first direction 401 than the main spacer 201, the first dummy spacer 202 and the second dummy spacer 203. When a position deviation occurs between the TFT array substrate 10 and the CF substrate 20 in the direction perpendicular to the first direction 401, the main spacer 201 can be still supported on the main stage 1011. Therefore, the support between the TFT array substrate 10 and the CF substrate 20 can be ensured without reducing the PS ratio of an area of spacers to an area of a panel display region, and an aperture ratio of pixels can be enhanced.

Referring to FIG. 4, a schematic diagram showing a display panel according to a third embodiment of the present invention is illustrated. The third embodiment is similar to the first or second embodiment, and the differences there-between are explained in further detail below.

In the display panel of the present embodiment, the pixel units further comprise fourth pixels 104 and fifth pixels 105. In a third direction 403, the fourth pixels 104 are adjacent to the first pixels 101. In a fourth direction 404, the fifth pixels 105 are adjacent to the first pixels 101. The fourth pixels 104 include third dummy stages 1041, and the fifth pixels 105 include fourth dummy stages 1051. The spacer assembly further comprises third dummy spacers 204 and fourth spacers 205.

In this case, the third direction 403 is opposite to the fourth direction 404, and the third direction 403 and the fourth direction 404 are perpendicular to the first direction 401 and the second direction 402. For example, the third direction 403 can be expressed as a −X axis direction, and the fourth direction 404 can be expressed as a +X axis direction.

In the display panel of the present embodiment, on a plane of the display panel, a projection of the third dummy spacer 204 is positioned in front of a projection of the third dummy stage 1041 in the third direction 403. That is, in the −X axis direction, an absolute coordinate value of the projection of the third dummy spacer 204 is larger than an absolute coordinate value of the projection of the third dummy stage 1041. In the fourth direction 404, a projection of the fourth spacer 205 is positioned in front of a projection of the fourth dummy stage 1051. That is, in the +X axis direction, a coordinate value of the projection of the fourth spacer 205 is larger than a coordinate value of the projection of the fourth dummy stage 1051.

A projected area of the third dummy stages is larger than a projected area of the third dummy spacers 204, and a projected area of the fourth dummy stages is larger than a projected area of the fourth dummy spacers 205.

In the display panel of the present embodiment, the third dummy stage 1041 and the fourth dummy stage 1051 are disposed on the TFT array substrate 10, and the third dummy spacers 204 and the fourth dummy spacers 205 are disposed on the CF substrate 20. The third dummy spacers 204 and the fourth dummy spacers 205 are positioned at different sides (in the third direction 403 and the fourth direction 404) of the third dummy stage 1041 and the fourth dummy stage 1051, respectively. For example, when the CF substrate 20 is shifted a distance with respect to the TFT array substrate 10 in the third direction 403, the fourth dummy spacers 205 can also be shifted to and thus in contact with the fourth dummy stage 1051. Furthermore, for example, when the CF substrate 20 is shifted a distance with respect to the TFT array substrate 10 in the fourth direction 404, the third dummy spacers 204 can also be shifted to and thus in contact with the third dummy stage 1041. Therefore, the support between the TFT array substrate 10 and the CF substrate 20 can be ensured without reducing the PS ratio of an area of spacers to an area of a panel display region, and an aperture ratio of pixels can be enhanced.

The present invention has been described above with a preferred embodiment thereof, and it is understood that many changes and modifications to the described embodiment can be carried out without departing from the scope and the spirit of the invention that is intended to be limited only by the appended claims.

1. A display panel, wherein the display panel comprises:
a thin film transistor (TFT) array substrate;
a color filter (CF) substrate assembled to the TFT array substrate; and
a liquid crystal layer disposed between the TFT array substrate and the CF substrate;
wherein the TFT array substrate includes at least two pixel units, and the pixel units comprise first pixels, second pixels and third pixels, and the second pixels are adjacent to the first pixels in a first direction, and the third pixels are adjacent to the first pixels in a second direction, and the first pixels include main stages, and the second pixels include first dummy stages, and the third pixels include second dummy stages;
wherein the CF substrate includes at least one spacer assembly, and the spacer assembly comprises main spacers, first dummy spacers and second spacers;
wherein the main stages on the TFT array substrate are positioned to the main spacers on the CF substrate, and the main stages are in contact with the main spacers;
wherein, when a position deviation occurs between the main stages and the main spacers, the first dummy spacers are positioned to and supported by the first dummy stages;
wherein, when another position deviation occurs between the main stages and the main spacers, the second dummy spacers are positioned to and supported by the second dummy stages.

2. The display panel according to claim 1, wherein, on a plane of the display panel, a projection of the first dummy spacer is positioned in front of a projection of the first dummy stage in the first direction, and a projection of the second spacer is positioned in front of a projection of the second dummy stage in the second direction.

3. The display panel according to claim 2, wherein a length of the main stages in a direction perpendicular to the first direction is greater than a length of the main spacers in the direction.

4. The display panel according to claim 2, wherein the pixel units further comprise fourth pixels and fifth pixels, and the fourth pixels are adjacent to the first pixels in a third direction, and the fifth pixels are adjacent to the first pixels in a fourth direction, and the fourth pixels include third dummy stages, and the fifth pixels include fourth dummy stages, and the spacer assembly further comprises third dummy spacers and fourth spacers.

5. The display panel according to claim 4, wherein, on a plane of the display panel, a projection of the third dummy spacer is positioned in front of a projection of the third dummy stage in the third direction, and a projection of the fourth spacer is positioned in front of a projection of the fourth dummy stage in the fourth direction.

6. The display panel according to claim 1, wherein the fourth dummy spacers are positioned to and supported by the fourth dummy stages when a position deviation in the third direction occurs between the TFT array substrate and the CF substrate, and the fifth dummy spacers are positioned to and supported by the fifth dummy stages when a position deviation in the fourth direction occurs between the TFT array substrate and the CF substrate.

7. A display panel, wherein the display panel comprises:
a TFT array substrate;
a CF substrate assembled to the TFT array substrate; and
a liquid crystal layer disposed between the TFT array substrate and the CF substrate;
wherein the TFT array substrate includes at least two pixel units, and the pixel units comprise first pixels, second pixels and third pixels, and the second pixels are adjacent to the first pixels in a first direction, and the third pixels are adjacent to the first pixels in a second direction, and the first pixels include main stages, and the second pixels include first dummy stages, and the third pixels include second dummy stages;
wherein the CF substrate includes at least one spacer assembly, and the spacer assembly comprises main spacers, first dummy spacers and second spacers;
wherein the main stages on the TFT array substrate are positioned to the main spacers on the CF substrate, and the main stages are in contact with the main spacers.

8. The display panel according to claim 7, wherein the first dummy spacers are positioned to and supported by the first dummy stages when a position deviation occurs between the main stages and the main spacers, and the second dummy spacers are positioned to and supported by the second dummy stages when another position deviation occurs between the main stages and the main spacers.

9. The display panel according to claim 7, wherein, on a plane of the display panel, a projection of the first dummy spacer is positioned in front of a projection of the first dummy stage in the first direction, and a projection of the second spacer is positioned in front of a projection of the second dummy stage in the second direction.

10. The display panel according to claim 9, wherein a length of the main stages in a direction perpendicular to the first direction is greater than a length of the main spacers in the direction.

11. The display panel according to claim 9, wherein the pixel units further comprise fourth pixels and fifth pixels, and the fourth pixels are adjacent to the first pixels in a third direction, and the fifth pixels are adjacent to the first pixels in a fourth direction, and the fourth pixels include third dummy stages, and the fifth pixels include fourth dummy stages, and the spacer assembly further comprises third dummy spacers and fourth spacers.

12. The display panel according to claim 11, wherein, on a plane of the display panel, a projection of the third dummy spacer is positioned in front of a projection of the third dummy stage in the third direction, and a projection of the fourth spacer is positioned in front of a projection of the fourth dummy stage in the fourth direction.

13. The display panel according to claim 11, wherein the fourth dummy spacers are positioned to and supported by the fourth dummy stages when a position deviation in the third direction occurs between the TFT array substrate and the CF substrate, and the fifth dummy spacers are positioned to and supported by the fifth dummy stages when a position deviation in the fourth direction occurs between the TFT array substrate and the CF substrate.

14. A display apparatus, comprising:
a backlight module; and
a display panel comprising:
a TFT array substrate;
a CF substrate assembled to the TFT array substrate; and
a liquid crystal layer disposed between the TFT array substrate and the CF substrate;
wherein the TFT array substrate includes at least two pixel units, and the pixel units comprise first pixels, second pixels and third pixels, and the second pixels are adjacent to the first pixels in a first direction, and the third pixels are adjacent to the first pixels in a second direction, and the first pixels include main stages, and the second pixels include first dummy stages, and the third pixels include second dummy stages;
wherein the CF substrate includes at least one spacer assembly, and the spacer assembly comprises main spacers, first dummy spacers and second spacers;
wherein the main stages on the TFT array substrate are positioned to the main spacers on the CF substrate, and the main stages are in contact with the main spacers.

15. The display apparatus according to claim 14, wherein the first dummy spacers are positioned to and supported by the first dummy stages when a position deviation occurs between the main stages and the main spacers, and the second dummy spacers are positioned to and supported by the second dummy stages when another position deviation occurs between the main stages and the main spacers.

16. The display apparatus according to claim 14, wherein, on a plane of the display panel, a projection of the first dummy spacer is positioned in front of a projection of the first dummy stage in the first direction, and a projection of the second spacer is positioned in front of a projection of the second dummy stage in the second direction.

17. The display apparatus according to claim 16, wherein a length of the main stages in a direction perpendicular to the first direction is greater than a length of the main spacers in the direction.

18. The display apparatus according to claim 16, wherein the pixel units further comprise fourth pixels and fifth pixels, and the fourth pixels are adjacent to the first pixels in a third direction, and the fifth pixels are adjacent to the first pixels in a fourth direction, and the fourth pixels include third dummy stages, and the fifth pixels include fourth dummy stages, and the spacer assembly further comprises third dummy spacers and fourth spacers.

19. The display apparatus according to claim 18, wherein, on a plane of the display panel, a projection of the third dummy spacer is positioned in front of a projection of the third dummy stage in the third direction, and a projection of the fourth spacer is positioned in front of a projection of the fourth dummy stage in the fourth direction.

20. The display apparatus according to claim 18, wherein the fourth dummy spacers are positioned to and supported by the fourth dummy stages when a position deviation in the third direction occurs between the TFT array substrate and the CF substrate, and the fifth dummy spacers are positioned to and supported by the fifth dummy stages when a position deviation in the fourth direction occurs between the TFT array substrate and the CF substrate.
